(19) United States
(12) Patent Application Publication
(10) Pub. No.: US 2013/0317900 A1
(43) Pub. Date: Nov. 28, 2013

(54) SYSTEM AND METHOD FOR PROVIDING REWARD PROGRAMS AS AN ELECTRONICALLY MEDIATED SERVICE

(71) Applicants: THERON RANDY FENNEL, ISSAQUAH, WA (US); DAVID LEEDS, SEATTLE, WA (US)

(72) Inventors: THERON RANDY FENNEL, ISSAQUAH, WA (US); DAVID LEEDS, SEATTLE, WA (US)

(21) Appl. No.: 13/897,383

(22) Filed: May 18, 2013

Related U.S. Application Data
(63) Continuation-in-part of application No. 13/481,768, filed on May 25, 2012.

(51) Int. Cl. G06Q 30/02

(52) U.S. Cl. CPC G06Q 30/0226
USPC 705/14.33; 705/14.27

(57) ABSTRACT

A method and system include a server module that provides reward as a service to customers via an electronics communications network. The customers then use separate and customized reward system software authorizations to generate, manage and issue reward account information to recipients. The deployment of the invented software may be accomplished by means of a plurality of client software operating on separately addressable client machines. The server module may be adapted to offer distinguishable groups of reward choices via different software interfaces. The invented method optionally offers an application program interface that enables communication between each configurable and configured client software and a rewards application server. The optional rewards application server is adapted to directly or indirectly fulfill reward issuance requests.

### CO-PENDING PROVISIONAL PATENT APPLICATION

This Nonprovisional patent application is a Continuation-in-Part application to Nonprovisional patent application Ser. No. 13/481,768 filed on May 25, 2012. Nonprovisional patent application Ser. No. 13/481,768 is hereby incorporated by reference in its entirety and for all purposes, to include claiming benefit of the priority date of filing of Nonprovisional patent application Ser. No. 13/481,768.

### FIELD OF THE INVENTION

The present invention relates to information technology applied to electronically mediated reward account generation and management. More specifically, but not by way of limitation, embodiments of the present invention relate to creating, populating and deploying reward accounts, to include gift accounts, in concert with an electronic communications network.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Reward accounts are increasingly popular with consumers and used by marketers and firms to build customer loyalty and strengthen new relationships with customers. The prior art provides methods and means to establish, manage and deliver access to gift accounts and other reward accounts via the Internet and other electronic communications networks. However, due to logistical complications and regulatory barriers, the prior art places undesirable burdens on account managers wishing to enable their customers and their own managers and employees to have reward accounts and credits authorized for and delivered to recipients. The prior art, moreover, fails to optimally provide communication tools that empower the deployment of and access to configurable interfaces that enable account managers to customize reward account management processes.

There is therefore a long felt need to provide systems and methods that enable an entity to establish electronically mediated reward systems programs that reduce the administrative and regulatory burden on the parties that direct and initiate the generation, authorization and delivery of access to award accounts to employees, customers and other third parties.

### SUMMARY AND OBJECTS OF INVENTION

It is an object of the present invention to provide a method and a system that enable reward account management made accessible by one or more electronic communication networks.

Towards these objects and other objects that will be made obvious in light of this disclosure, a system and method are the method of the present invention (hereinafter, “the invented method”) which empowers a rewards service provider to procure and generate rewards and rewards accounts as requested by a first party, and transmit related reward and reward account information to a second party, or recipient, wherein the recipient may be identified by the first party. The service provider is optionally enabled to configure of a plurality of customized software elements that are adapted to support the generation and management of reward accounts and generate and/or purchase rewards as directed by the reward account holder.

A second preferred embodiment of the invented system includes a server module that provides selectable rewards services to platform level customers, wherein platform level customers (hereinafter, “platform customers”) are those parties, entities or persons enabled to create rewards management accounts for their own use and/or use by other parties, to include tier 2 customers and tier 3 customers, as authorized by the platform customer. The service provider may optionally present a set of reward options from which the platform customer assigns a unique subset of reward selections to one or more reward accounts, wherein these established reward selection subsets and associated reward accounts are preferably maintained by the service provider. Each reward account may thereby specify a particular account holder identifier and associate a unique subset of rewards from which a customer authorized by the platform customer may direct the service provider to purchase and to assign, or communicate information regarding, to a recipient.

A platform customer is preferably empowered to form and optionally fund at least two types of reward accounts, namely (a.) a platform reward account that enables the platform customer itself to request reward purchases and identify intended recipients of reward purchases; and (b.) a tier 2 reward account that empowers a tier 2 customer to fund and request reward purchases and identify intended recipients of reward purchases. In an optional aspect of the invented method, a tier 2 customer may be empowered by the platform customer to create tier 3 reward accounts, wherein the tier 3 reward account empowers a tier 3 customer to fund and/or request reward purchases and identify intended recipients of reward purchases. It is understood that tier 3 customers are generally, but not exclusively, a unit of a same business or corporate entity of the tier 2 customer that authorized or formed the associated tier 3 reward account. It is further understood that a tier 2 customer may be empowered to generate a unique subset of reward selections from which a tier 3 reward account may select rewards for purchase, issuance and transmission to a recipient. It is also understood that the platform customer itself may be authorized by the service provider to generate tier 3 accounts.

It is understood that a tier 2 customer is a person, party or entity that is enabled or authorized to access and apply a tier 2 reward account record. It is also understood that a tier 3 customer is a person, party or entity that is enabled or authorized to access and apply a tier 3 reward account record.

Tier 2 and tier 3 customers may optionally use separate and particularly structured reward system software to generate and issue rewards to reward account recipients, which each individual reward account enables a user to select from a pre-established subset of rewards. The deployment of the reward selection, access and account management software may be accomplished by means of a plurality of client software operating on separately addressable client machines. The server module may be adapted to offer distinguishable groups of reward choices to particular platform, tier 2 and tier 3 account customers.

A second alternate preferred embodiment of the invented method further comprises a reward accounts system and method for (a.) interacting with a data processing system using a graphical user interface as rendered by a platform customer, a tier 2 customer or a tier 3 customer over a computer network to enable the authorized customer to direct the data processing system to perform management tasks including, but not limited to, (i.) creating reward accounts; (ii.) assigning passwords to reward accounts; (iii.) resetting passwords of reward accounts; (iv.) electronically transferring funds to and from reward accounts; (v.) accessing financial balances of reward accounts; (vi.) assigning reward options to reward accounts; and (vii.) deleting reward accounts. The invented method further enables presenting recipients of reward accounts with reward choices from which reward options may be selected via a graphical user interface.

This Summary is provided to introduce a selection of concepts in a simplified form that are further described below in the Detailed Description. This Summary is not intended to identify key features or essential features of the claimed subject matter, nor is this Summary intended to be used to limit the scope of the claimed subject matter.

### BRIEF DESCRIPTION OF THE FIGURES

These, and further features of the invention, may be better understood with reference to the accompanying specification and drawings depicting the preferred embodiment, in which:

FIG. 1 is a network diagram depicting an environment and structure of the invented service;

FIG. 2A is a screenshot depicting an example of a customer dashboard interface as rendered by a tier 2 system or tier 3 system of FIG. 1;

FIG. 2B is a screen shot depicting an example of a customer access interface to the invented service of the customer dashboard interface of FIG. 2A;

FIG. 3 is a flowchart of software directed aspects the admin server of FIGS. 1 and 5 creating and applying a tier 2 reward account record or a tier 3 reward account record of FIG. 8C in interaction with the platform system of FIGS. 1 and 6 and a tier 2 system and/or a tier 3 system of FIGS. 1 and 7;

FIG. 4 is a process chart depicting a detailed view of additional optional aspects of an alternative operations cycle of the invented service;

FIG. 5 is a block diagram depicting the hardware and software elements of the admin server of FIG. 1;

FIG. 6 is a block diagram depicting the hardware and software elements of the platform server of FIG. 1;

FIG. 7 is a block diagram depicting the hardware and software elements of the tier 2 system of FIG. 1;

FIG. 8A is a block diagram of an exemplary first reward account record as stored by the admin server of FIG. 1;

FIG. 8B is a block diagram depicting an admin reward menu as stored by the admin server of FIG. 1;

FIG. 8C is a block diagram of an exemplary plurality of reward account records as stored by the admin server of FIG. 1;

FIG. 8D is a block diagram depicting an exemplary first recipient database record as stored by the admin server of FIGS. 1 and 5 and/or a tier 2 system or a tier 3 system of FIGS. 1 and 7;

FIG. 8E is a block diagram of an exemplary first interface request message as transmitted by a tier 2 system or a tier 3 system of FIGS. 1 and 7 to the admin server of FIGS. 1 and 5;

FIG. 8F is a block diagram of an exemplary first interface delivery message as transmitted by the admin server of FIGS. 1 and 5 and to a tier 2 system or a tier 3 system of FIGS. 1 and 7;

FIG. 8G is a block diagram depicting an exemplary reward selection message as sent from a tier 2 system or tier 3 system of FIGS. 1 and 7 to an admin server of FIGS. 1 and 5;

FIG. 8H is a block diagram of an exemplary reward purchase message as sent from the admin server of FIGS. 1 and 5 to a reward source server of FIG. 1;

FIG. 8I is a block diagram of an exemplary reward fulfillment message as sent from the reward source server of FIG. 1 to the admin server of FIGS. 1 and 5;

FIG. 8J is a block diagram of an exemplary reward transmission message as sent from the admin server of FIGS. 1 and 5 to a recipient system of FIG. 1;

FIG. 9 is a software chart depicting a platform server of FIGS. 1 and 6 establishing a tier 2 customer account or a tier 3 customer account of FIG. 8C;

FIG. 10A is a flow chart depicting platform customer of FIGS. 1 and 6 requesting of the admin server FIGS. 1 and 7 a formation of a tier 2 customer account or a tier 3 customer account of FIG. 8C;

FIG. 10B is a flow chart depicting the admin server FIGS. 1 and 7 creating a tier 2 customer account or a tier 3 customer account of FIG. 8C;

FIG. 11A is a flow chart depicting of a tier 2 customer or a tier 3 customer accessing a tier 2 or tier 3 account of FIG. 8C;

FIG. 11B is a flow chart depicting the admin server of FIGS. 1 and 7 accessing and revising a tier 2 or tier 3 account record of FIG. 8C;

FIG. 12A is a flow chart depicting a tier 2 customer or a tier 3 customer funding a tier 2 account or tier 3 account of FIG. 8C;

FIG. 12B is a flow chart depicting the admin server of FIGS. 1 and 7 receiving account funding from a platform customer, a tier 2 customer or a tier 3 customer of an account record of FIG. 8C; and

FIG. 13 is a flow chart depicting a reward source server of FIG. 1 processing a reward purchase.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events, which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

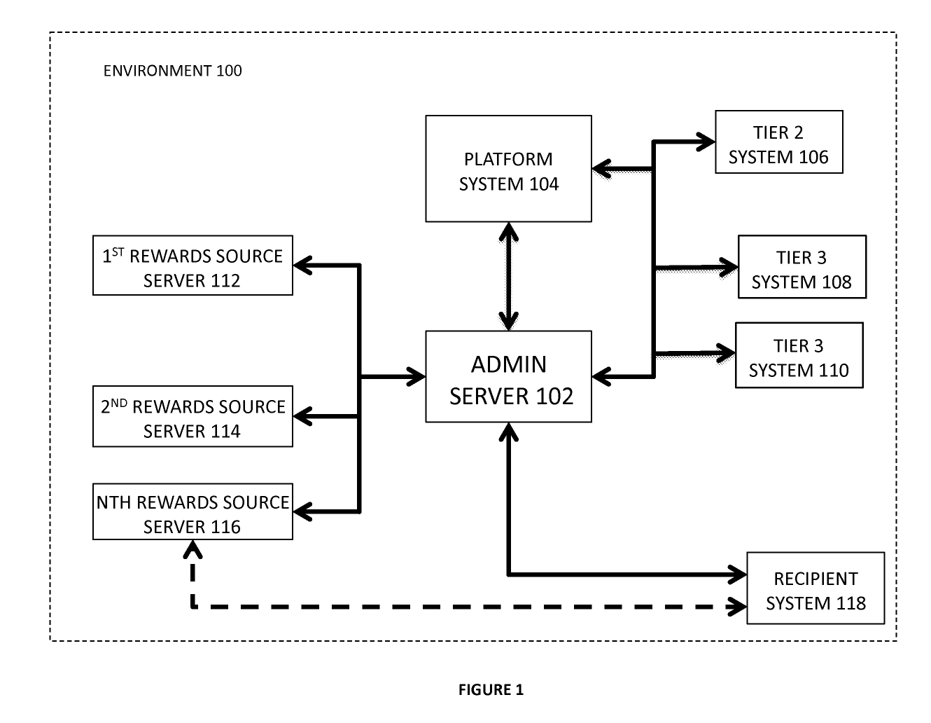

Referring now generally to the Figures and particularly to FIG. 1, FIG. 1 is a network diagram depicting an environment and structure of the invented service. FIG. 1 illustrates an electronics communication and computing environment 100 (hereinafter, “environment 100”) of participating systems 102-118 of the invented method and service. An API and administrative server 102 is bi-directionally communicatively coupled with a plurality of additional participant servers and systems 104-118. The environment 100 may include the Internet and/or telephony communications links as means to interconnect the plurality of network participant servers and systems 102-118. The API and administrative server 102 (hereinafter, “admin server 102”) accepts account creation interactions with a platform system 104 whereby by reward accounts, e.g., platform reward accounts, tier 2 reward accounts and optionally tier 3 reward accounts, are formed. Further optionally and additionally, tier 2 systems 106 and tier 2 customers may be empowered to create reward accounts for use by tier 3 customers.

Rewards source servers 112, 114 & 116 are accessed by the admin server 102 to request the generation of rewards that are then delivered to or made accessible to recipients, optionally by (a.) emailing reward account information from the admin server 102 to a recipient network address, e.g., and email address or a text service address such as a phone number; (b.) emailing reward account information from the admin server 102 to a recipient network address, e.g., and email address or a text service address such as a phone number; and/or (c.) a postal mailing of a physical card with reward account information. Exemplary reward account sources include gift card purchasing services provided by the STARBUCKS™ café chain, the HOME DEPOT™ corporation, and NORDSTROM™ department store corporation.

One or more participant systems and servers 102-118 may be or comprise a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7™ operating system marketed by Microsoft Corporation of Redmond, Wash.; (d.) a MACBOOK PRO™ personal computer as marketed by Apple, Inc. of Cupertino, Calif.; (e.) an IPAD™ tablet computer as marketed by Apple, Inc. of Cupertino, Calif.; (f.) an IPHONE™ cellular telephone as marketed by Apple, Inc. of Cupertino, Calif.; (g.) an HTC TITAN II™ cellular telephone as marketed by AT&T, Inc. of Dallas, Tex. and running a WINDOWS 7™ operating system as marketed by Microsoft Corporation of Redmond, Wash.; (h.) a GALAXY NEXUS™ smart phone as marketed by Samsung Group of Seoul, Republic of Korea or and running an ANDROID™; (i.) a TOUGHPAD™ tablet computer as marketed by Panasonic Corporation of Kadoma, Osaka, Japan and running an ANDROID™ operating system as marketed by Google, Inc. of Mountain View, Calif.; or (j.) other suitable computational system or electronic communications device known in the art capable of providing or enabling a webservice, internet-based communications, or electronic network-based communication known in the art.

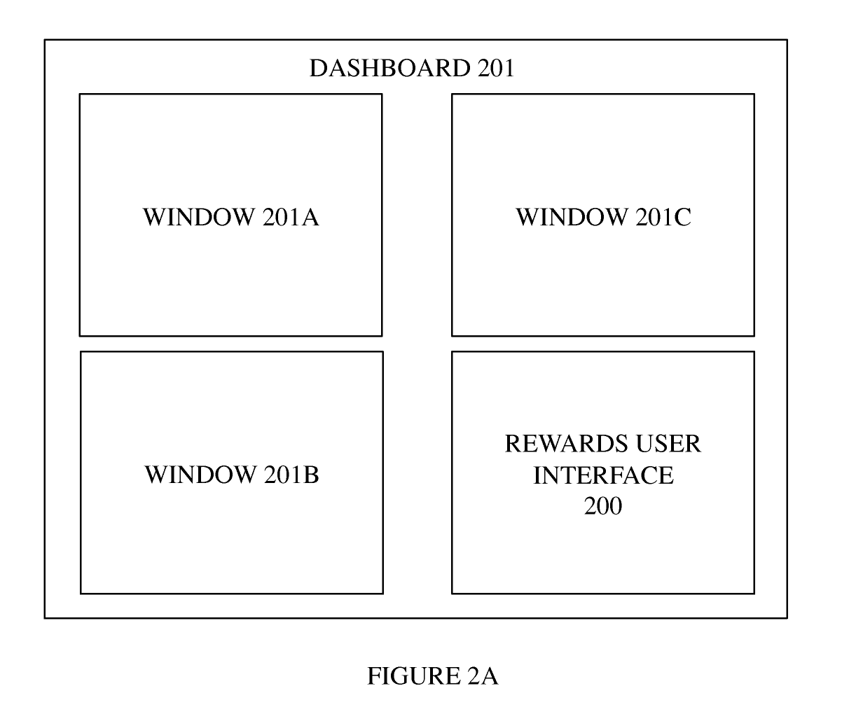

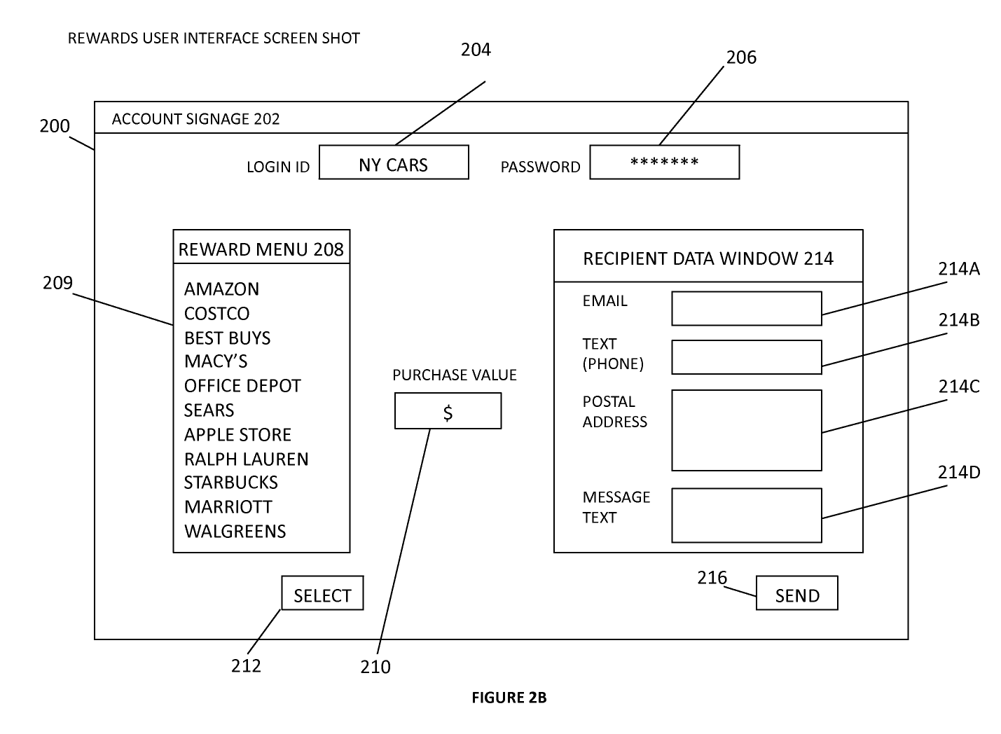

Referring now generally to the Figures and particularly to FIG. 2A, FIG. 2A is a screen shot depicting an example of a rewards user interface 200 as rendered within a customer access interface 201. The customer access interface dashboard 201 (hereinafter, “dashboard 201”) is generated by transmission from the platform system 104 and rendered by a tier 2 system 106 or a tier 3 system 108 & 110. For example, and not offered as a limitation, the platform system 104 may include a webserver software SW.WEBS that provides and transmits an interface code 104B and the rendering tier 2 system 106 or tier 3 system 110 may include a web browser SW.WB that applies the received interface code 104B to cause a local rendering of the dashboard 201 by the receiving tier 2 system 106 or tier 3 system 108 & 110. The dashboard 201 includes a plurality of windows 201A-201C that enable various functionalities as well as the rewards user interface 200.

Referring now generally to the Figures and particularly to FIG. 2B, FIG. 2B is an exemplary screen shot of the rewards user interface 200 rendered at a tier 2 system 106 a tier 3 system 108 & 110. The rewards user interface 200 enables a tier 2 customer or a tier 3 customer to provide the admin server 102 with (a.) rewards selections by type and purchase value, i.e., by specifying dollar value to be expended in purchasing a reward; (b.) one or more recipient identifiers or addresses, e.g., a telephony address, an email address and/or a postal address; (c.) a text message or other data to be transmitted in association with reward account information to a recipient address; and (d.) other information related to an intended recipient, e.g., a name or nick name of the recipient.

The tier 2 system 106 a tier 3 system 108 & 110 first renders rewards user interface 200 as provided within the dashboard 200 provided by the platform server 104. It is understood that the following discussion of operation of the tier 2 system 106 and tier 2 customer actions may equally apply, in whole or in part, to tier 3 systems 108 & 110 and tier 3 customers.

The rewards user interface 200 displays a signage 202 related to the tier 2 system and accepts a login identifier through a login window 204 and also a user password through a password window 206. The tier 2 customer may then select a particular reward signage 208A-208K from a rewards menu 209 and enter a value level of the selected reward through a purchase value window 210. The tier 2 user than applied the select button to input the reward source selection as selected from the reward menu 209 and the purchase value as entered into the purchase value window 210 by actuating the select button 212. The tier 2 customer may further input recipient information 214A-214D through the recipient data window 214, and direct the reward selection and purchase value information and recipient information to be sent directly to the admin server 102 by actuation of a send button 216. By this direction communication between the tier 2 system 106 and tier 3 systems 108 & 110, the platform customer and platform server 104 are relieved from the administrative and regulatory burdens of handling or taking possession of funds provided by tier 2 and tier 3 customers in the process of funding, selecting and purchasing rewards and initiating rewards accounts. The recipient data window 214 is adapted to accepts a recipient email address through an email address data entry window 214A, a recipient telephone or text number through a text/phone data entry window 214B, a recipient postal address through a postal data entry window 214C, and optionally additional textual or other data that is to be transmitted to a recipient through a message data entry window 214B.

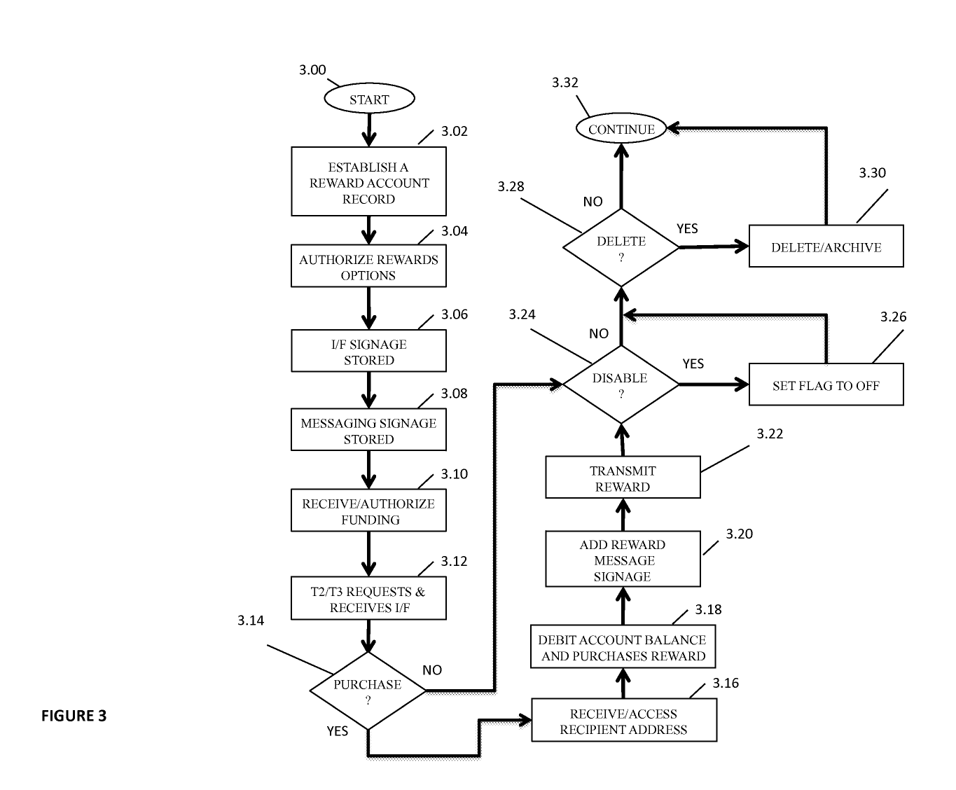

Referring now generally to the Figures and particularly to FIG. 3, FIG. 3 is a software flowchart depicting an overview of certain optional aspects of an alternative operating cycle of the admin server in accordance with the invented service.

The admin server 102 establishes a reward account record REW.ACCT.REC.001-REW.ACCT.REC.N in step 3.02 and populates the newly formed reward account record with an account identifier and a password. In step 3.04 the admin server includes reward identifiers in the instant reward account record REW.ACCT.REC.001-REW.ACCT.REC.N as directed by the platform server 104. The admin server 102 receives in step 3.06 an interface signage I.SIGN and stores the received interface signage I.SIGN in the instant reward account record REW.ACCT.REC.001-REW.ACCT.REC.N. This interface signage data I.SIGN will optionally be provided by the admin server 102 for rendering by any system 104-110 that requests a rendering of rewards user interface 200 within a request to access the instant reward account record REW.ACCT.REC.001-REW.ACCT.REC.N.

The admin server 102 next preferably receives a messaging signage data M.SIGN in step 3.08 that will optionally be provided in messages that contains information sent to reward recipients and related to reward purchases made in an access of the instant reward account record REW.ACCT.REC.001-REW.ACCT.REC.N. The interface signage data I.SIGN and the messaging signage data M.SIGN are preferably stored within the same instant reward account record REW.ACCT.REC.001-REW.ACCT.REC.N.

The admin server 102 additionally and preferably receives a funding balance REW.BAL or an access to funding credit for the instant reward account record REW.ACCT.REC.001-REW.ACCT.REC.N in step 3.10. The admin server 104 receives a request in step 3.12 for the rewards user interface 200 in step 3.12 and after authenticating a received account identifier REW.ACCT.ID and password REW.PASS transmits the rewards user interface 200 to the requesting system 104-110.

The admin server 102 determines whether a request to purchase has been received in step 3.14 with a reward identifier REW.ID and, if so, proceeds to access or accept a reward recipient address RCP.ADDR of the recipient system 118 in step 3.16. The admin server 102 the purchases the requested reward associated with the instant reward identifier REW.ID by communication with a rewards source server 112-116 and debits the funding balance REW.BAL of the instant reward account record REW.ACCT.REC.001-REW.ACCT.REC.Nin step 3.18. The admin server formats a reward transmission message TMSG.001-TMSG.N and adds a message signage thereto in step 3.20, and transmits the reward transmission message TMSG.001-TMSG.N with reward access data REW.ACCESS in step 3.22 to the recipient system 118.

The admin server 102 determines in step 3.24 whether a direction to disable the instant reward account record REW.ACCT.REC.001-REW.ACCT.REC.N has been received from an authorized and authenticated platform customer or other authorized and authenticated party, and to proceed to switch a enabled/disabled indicator FLAG from ON to OFF of the instant rewards account record REW.ACCT.REC.001-REW.ACCT.REC.N in step 3.26 when such an authorized and authenticated instruction has been received.

The admin server 102 determines in step 3.28 whether a direction to delete and or delete and archive the instant reward account record REW.ACCT.REC.001-REW.ACCT.REC.N has been received from an authorized and authenticated platform customer or other authorized and authenticated party, and to delete and optionally archive the instant reward account record REW.ACCT.REC.001-REW.ACCT.REC.N when such an authorized and authenticated instruction to delete and/or delete and archive has been received.

The admin server 102 proceeds from either step 3.28 or step 3.30 to step 33.32 and to perform additional or alternative operation, so possibly include additional executions of steps 3.02 through 3.32.

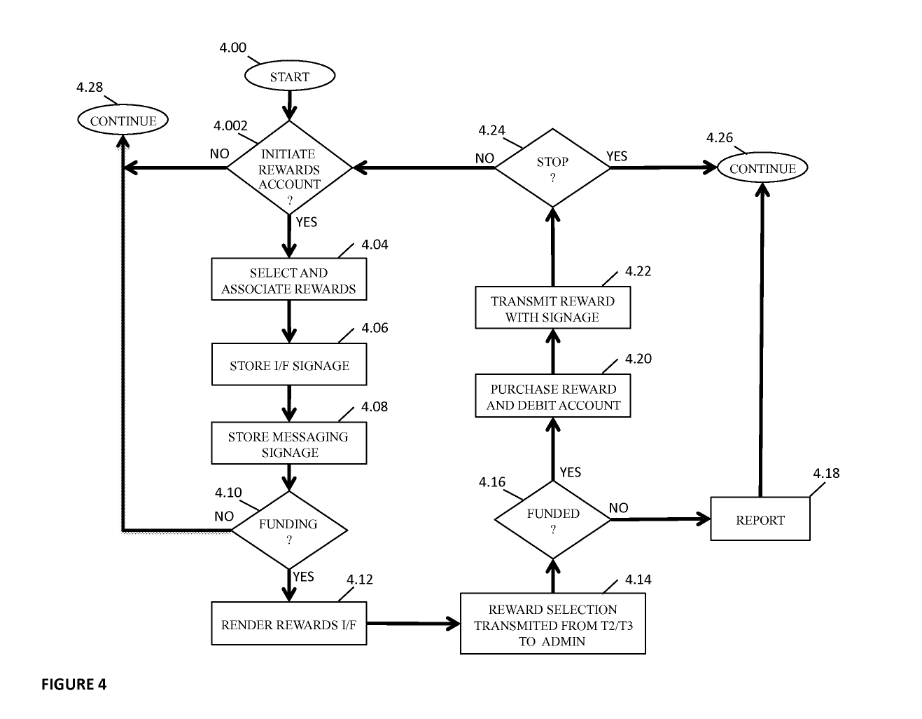

FIG. 4 is a process chart depicting a detailed view of additional optional aspects of an alternative operations cycle for the invented service. A rewards account record REW.ACCT.REC.001-REW.ACCT.REC.N may be initiated in step 4.02 and selections of rewards selections to be made available via the rewards account record REW.ACCT.REC.001-REW.ACCT.REC.N in step 4.04. Interface signage 202 and messaging signage M.SIGN related to a platform customer, tier 2 customer and/or tier 3 customer are optionally accepted and stored by the admin server 102. The rewards account record REW.ACCT.REC.001-REW.ACCT.REC.N may be funded in step 4.10 and the rewards user interface 200 is rendered by a tier 2 system 106 or a tier 3 system 108 & 110 in step 4.12. In step 4.14 the admin server 102 receives a reward selection message SMSG.001-SMSG.N from a tier 2 system 106 or a tier 3 system 108 & 110 that specifies a reward identifier REW1.ID-RWEN.ID and purchase value PRICE1-PRICEN and preferably a recipient identifier and/or a recipient address RCP.ADDR. The admin server 102 determines in step 4.16 whether the reward selection of step 4.14 is funded, and proceeds on to step 4.18 to report a lack of funding in step 4.18 to the system 104-110 that initiated the message of step 4.14. When the admin server 102 determines in step 4.16 that the reward selection of step 4.14 is funded, the admin server 102 proceeds on from step 4.14 to step 4.20 to purchase a reward and debit the credit balance of the relevant rewards account REW.ACCT.REC.001-REW.ACCT.REC.N. Rewards account information is then transmitted to a recipient address RCP.ACCT optionally with messaging signage M.SIGN in step 4.22. The admin server 102 determines in step 4.24 whether to proceed to another execution of step 4.02 or to proceed on to step 4.26 and to perform other computational operations. In another optional aspect of the invented method, the admin server 102 may proceed from step 4.02 to step 4.28 when no new account initiation request is detected.

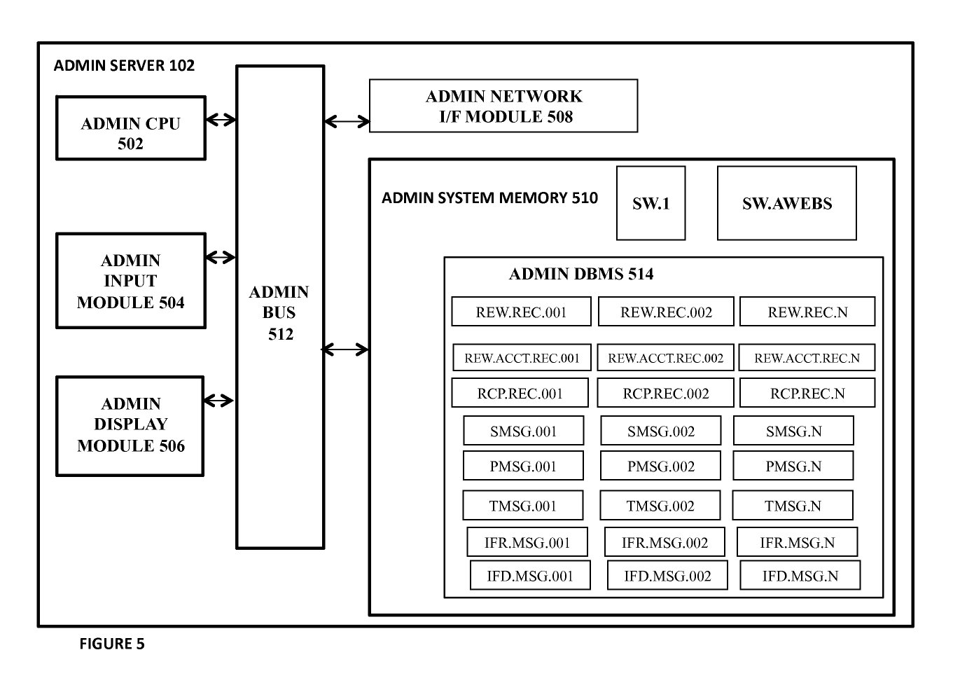

Referring now generally to the Figures and particularly to FIG. 5, FIG. 5 is a block diagram depicting the hardware and software elements of the admin server 102 of FIG. 1. The admin server 102 includes an admin central processing unit 502, an admin input module 504, an admin display module 506, an admin network interface module 508 and an admin system memory 510. The admin central processing unit 502 is bi-directionally communicatively coupled with the admin input module 504, the admin display module 506, the admin network interface module 508 and the admin system memory 510 by an internal admin communications bus 512.

The admin system memory 510 stores an admin software SW.1, an admin webserver software SW.AWEBS, a web browser software SW.WB and an admin database management system 514. The admin software SW.1 enables the admin server 102 to communicate with other servers and systems 104-118 of the environment 100 and to effect one or more aspects of the invented method. The admin webserver software SW.AWEBS maintains and generates software code that may be rendered as the rewards user interface 200 by the web browser SW.WB of the other participant systems 104-118.

The admin database management system 514 stores a plurality of records, to include reward account records REW.REC.001-REW.REC.N, reward records REW.REC.001-REW.REC.N, and recipient records RCP.REC.001-RCP.REC.N. It is understood that one or more reward account records REW.REC.001-REW.REC.N may contain an account identifier and password that is authorized for use by a platform customer, a tier 2 customer and/or a tier 3 customer.

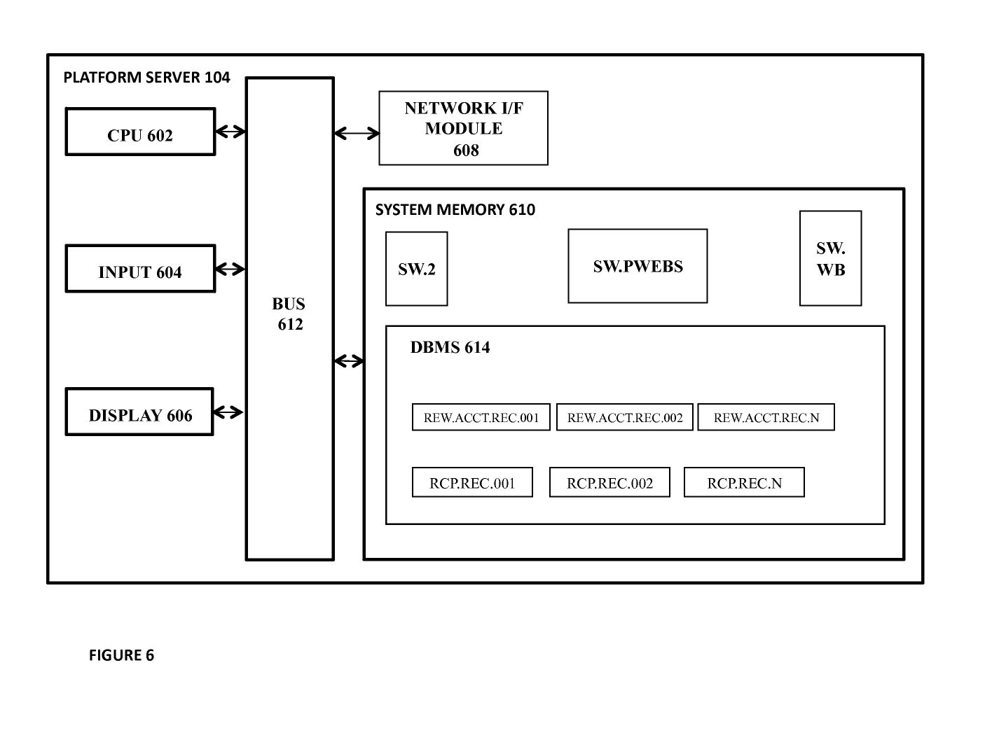

Referring now generally to the Figures and particularly to FIG. 6, FIG. 6 is a block diagram depicting the hardware and software elements of the platform server 104. The platform server 104 includes a platform central processing unit 602, a platform user input module 604, a platform display module 606, a platform network interface module 608 and a platform system memory 610. The platform central processing unit 602 is bi-directionally communicatively coupled with the platform input module 604, the platform display module 606, the platform network interface module 608 and the platform system memory 610 by an internal admin communications bus 612.

The platform system memory 610 stores a platform software SW.2, a platform webserver software software SW.PWEBS, and a platform database management system 614. The platform software SW.2 enables the platform server 102 to communicate with other servers and systems 104-118 of the environment 100 and to effect one or more aspects of the invented method. The platform webserver software SW.PWEBS maintains and generates software code that may be rendered as the dashboard 201 by the web browser SW.WB of the other participant systems 102 & 106-118.

The platform database management system 614 stores a plurality of records, to include reward account records REW.ACCT.REC.001-REW.ACCT.REC.N that individually designate separate and unique tier 2 accounts and tier 3 accounts, and recipient records RCP.REC.001-RCP.REC.N that individually contain information related to a same recipient and each preferably designate a different recipient.

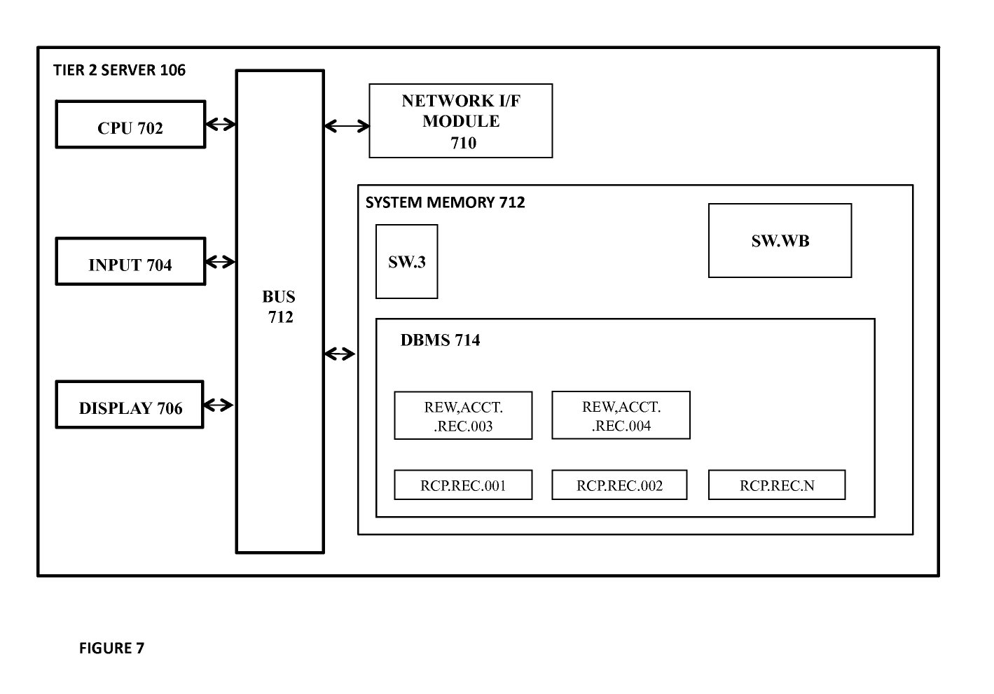

Referring now generally to the Figures and particularly to FIG. 7, FIG. 7 is a block diagram depicting the hardware and software elements of the tier 2 system 106. The tier 2 system 106 includes a tier 2 central processing unit 702, a tier 2 user input module 704, a tier 2 display module 706, a tier 2 network interface module 710 and a tier 2 system memory 712. The tier 2 central processing unit 702 is bi-directionally communicatively coupled with the tier 2 input module 704, the tier 2 display module 706, the tier 2 network interface module 710 and the tier 2 system memory 712 by a tier 2 internal admin communications bus 714.

The tier 2 system memory 712 stores a tier 2 software SW.3 a web browser software SW.WB and a tier 2 database management system 714. The tier 2 software SW.3 enables the tier 2 system 102 to communicate with other servers and systems 104-118 of the environment 100 and to effect one or more aspects of the invented method. The tier 2 database management system 714 stores a plurality of records, to include reward account records REW.ACCT.REC.004-REC.05 that each specify separate and unique tier 3 accounts, and recipient records RCP.REC.001-RCP.REC.N.

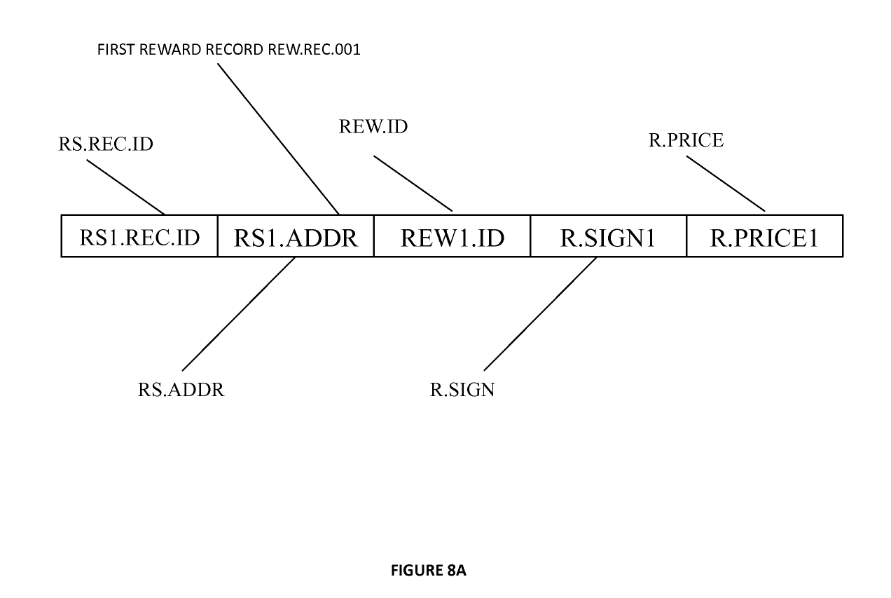

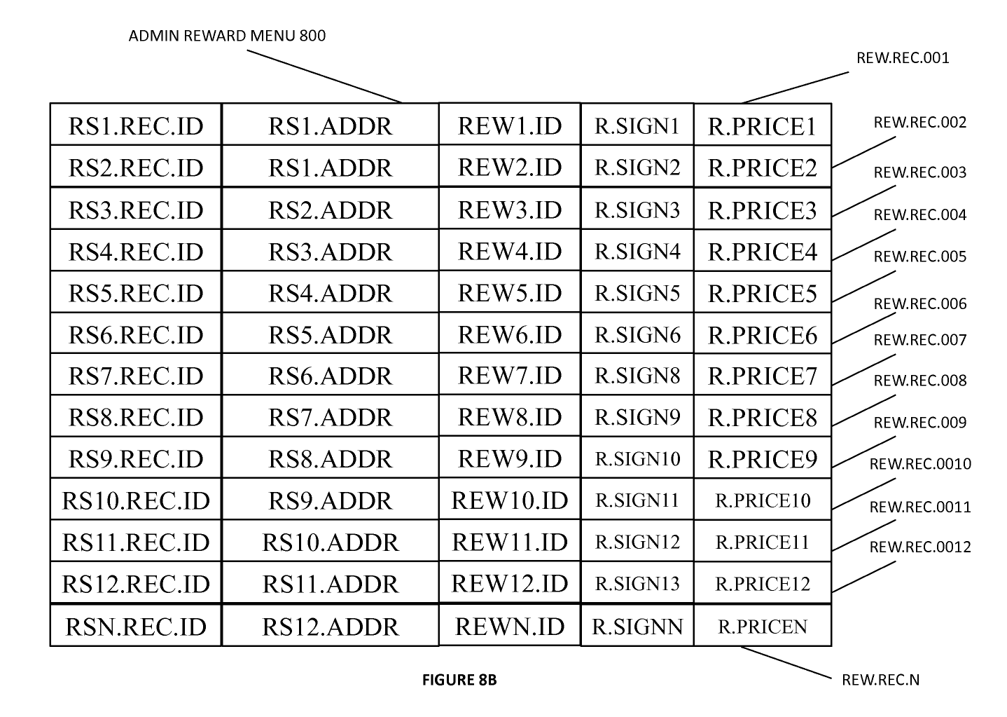

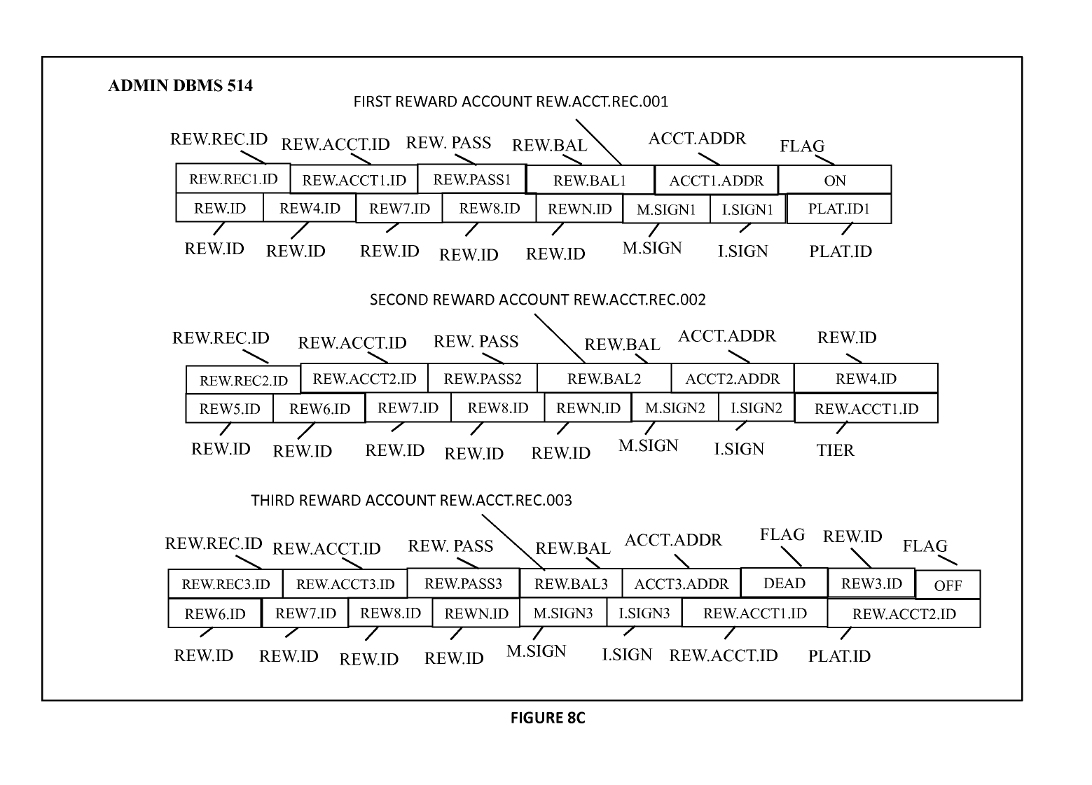

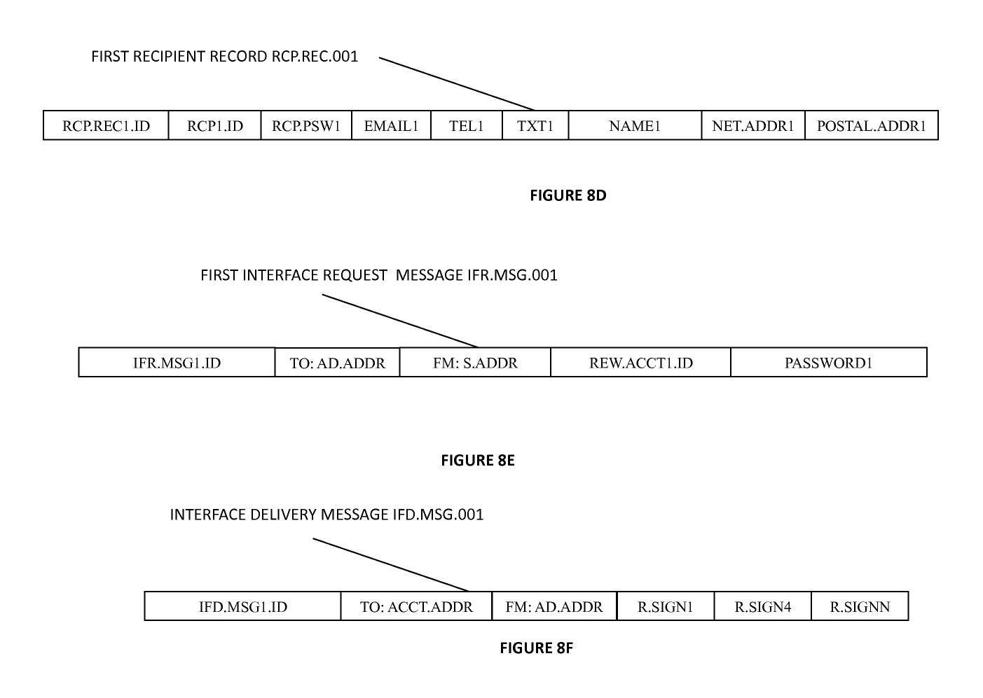

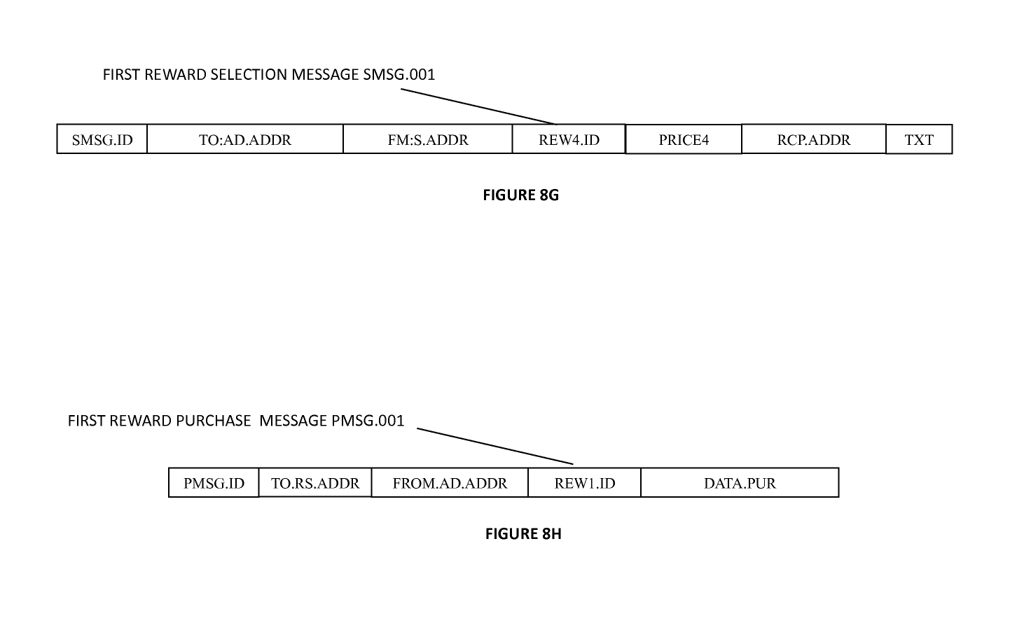

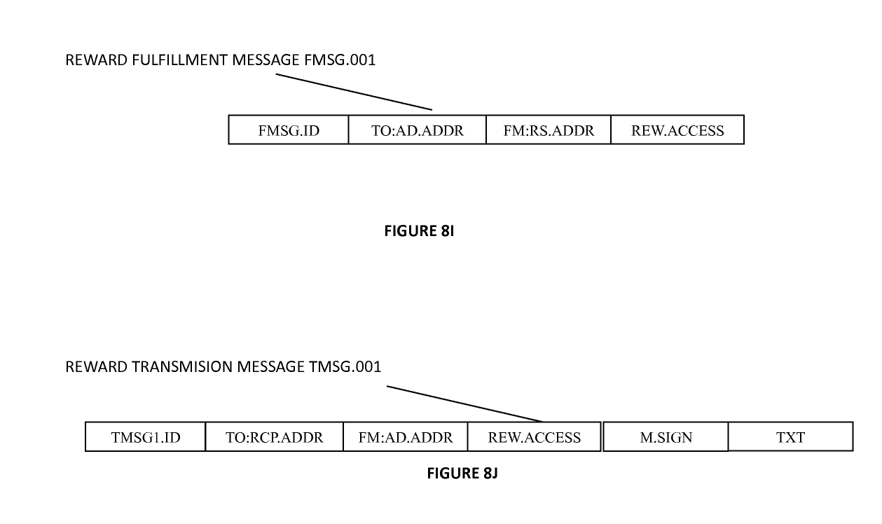

FIG. 8A is a block diagram of an exemplary first reward record REW.REC.001 as stored by the admin server 102 of FIG. 1. Each reward record REW.REC.001-REW.REC.N includes a reward source record identifier RS.REC.ID; a reward source network address RS.ADDR to which reward purchase messages PMSG.001-P.MSG.N shall be addressed, a reward identifier REW.ID that identifies the reward that has been selected for purchase; a reward signage R.SIGN that may be rendered within the rewards user interface 200 to a platform customer, a tier 2 customer, a tier 3 customer and/or other observers to identify the reward referenced by the associated reward identifier REW.ID, i.e., a text message of “NORDSTROM™ GIFT CARD”; and a purchase price of the reward R.PRICE.

The exemplary first reward record REW.REC.001 specifies a first reward source record identifier RS1.REC.ID; a first reward source network address RS1.ADDR to which reward purchase messages PMSG.001-P.MSG.N shall be addressed, a first reward identifier REW1.ID that identifies a first reward that has been selected for purchase; a first reward interface signage R.SIGN1 that may be rendered within the rewards user interface 200; and a first purchase price of a first reward R.PRICE1.

Referring now generally to the Figures and particularly to FIG. 8B, FIG. 8B is a block diagram depicting an admin reward menu 800 stored by the admin server 102 wherein the admin reward menu 800 includes the plurality of reward records REW.REC.001-RW.REC.N.

Referring now generally to the Figures and particularly to FIG. 8C, FIG. 8C is a block diagram of an exemplary plurality of reward account records REW.ACCT.REC.001-REW.ACCT.REC.003 of the reward account records REW.ACCT.REC.001-REW.ACCT.REC.N stored and maintained by the admin server 102. Each reward account record REW.ACCT.REC.001-REW.ACCT.REC.N includes a reward account record identifier REW.REC.ID, a reward account identifier REW.ACCT.ID, a reward account password REW.PASS, a credit balance REW.BAL; a listing of reward identifiers REW1.ID-REWN.ID of approved rewards that may be purchased in an application of the comprising reward account record REW.ACCT.REC.001-REW.ACCT.REC.N in accordance with the invented method; a message signage M.SIGN that may be sent to a recipient address RCP.ADDR when an electronic message is sent to a recipient associated with the recipient address RCP.ADDR; and an interface signage I.SIGN that may be supplied rendered as account signage 202 when an authorized user of the instant rewards account requests that the rewards user interface 200 be rendered for viewing, access and reward selection.

A first exemplary reward account record REW.ACCT.REC.001 defines a first tier 2 account that may be accessed by a tier 2 customer optionally as well as by a platform customer. The first reward account record REW.ACCT.REC.001 includes a first reward account record identifier REW.REC1.ID; a first reward account identifier REW.ACCT1.ID a first reward account password REW.PASS1; a first credit balance REW.BAL1; and a listing of reward identifiers REW2.1D-REW8.1D of approved rewards that may be purchased in an application of the comprising first reward account record REW.ACCT.REC.001 in accordance with the invented method. The first reward account record REW.ACCT.REC.001 optionally includes a first message signage M.SIGN1 that may be sent to a recipient address RCP.ADDR when an electronic message is sent to a recipient associated with the recipient address RCP.ADDR and a first interface signage I.SIGN1 that may be supplied rendered as the account signage 202 when an authorized user of the first tier 2 account requests that the rewards user interface 200 be rendered for viewing, access and reward selection.

The first exemplary reward account record REW.ACCT.REC.001 may further optionally include a platform account identifier PLAT.ID of the platform customer that authorized the admin server 102 to create and maintain the instant first exemplary reward account record REW.ACCT.REC.001, wherein the admin system 102 may optionally permit access to the first exemplary reward account record REW.ACCT.REC.001 by the identified platform customer and may authorize the platform customer to (a.) delete or modify the first exemplary reward account record REW.ACCT.REC.001; (b.) add or delete references to reward account records REW.REC.001-REW.REC.N whereby authority by the tier 2 customer to purchase rewards identifiers by associated identifiers REW1.ID-REWN.ID of the reward records REW.REC.001-REW.REC.N is created or removed; and/or (c.) adjust other aspects of the instant first reward account record REW.ACCT.REC.001. A first platform account identifier PLAT1.ID may be or include a platform account record identifier, e.g., a second rewards account identifier REW.ACCT2.ID of a second rewards account REW.ACCT.REC.002 and/or a second platform password REW.PASS2 of second rewards account REW.ACCT.REC.002.

A second exemplary reward account record REW.ACCT.REC.002 defines a platform account that may be accessed by a platform customer. The second reward account record REW.ACCT.REC.002 includes a second reward account record identifier REW.REC2.ID; a second reward account identifier REW.ACCT2.ID a second reward account password REW.PASS2; a second credit balance REW.BAL2; and a listing of reward identifiers REW2.ID-REW8.ID of approved rewards that may be purchased in an application of the comprising second reward account record REW.ACCT.REC.002 in accordance with the invented method. The second reward account record REW.ACCT.REC.002 optionally includes a second message signage M.SIGN2 that may be sent to a recipient address RCP.ADDR when an electronic message is sent to a recipient associated with the recipient address RCP.ADDR and a second interface signage I.SIGN2 that may be supplied rendered as the account signage 202 when an authorized user of the platform account requests that the rewards user interface 200 be rendered for viewing, access and reward selection.

The second exemplary reward account record REW.ACCT.REC.002 may further optionally include additional rewards account identifiers REW.ACCT1.ID-REW.ACCTN.ID that identify reward account records REW.ACCT.REC.001-REW.ACCT.REC.N that were or are authorized by the instant platform account as tier data TIER2 in a tier data field TIER.

A third exemplary reward account record REW.ACCT.REC.003 defines a tier 3 account that may be accessed by a tier 3 customer optionally as well as by a tier 3 customer and/or a platform customer. The third reward account record REW.ACCT.REC.003 includes a third reward account record identifier REW.REC3.ID; a third reward account identifier REW.ACCT3.ID a third reward account password REW.PASS3; a third credit balance REW.BAL3; and a listing of reward identifiers REW3.ID-REW8.ID of approved rewards that may be purchased in an application of the comprising third reward account record REW.ACCT.REC.003 in accordance with the invented method. The third reward account record REW.ACCT.REC.003 optionally includes a third message signage M.SIGN3 that may be sent to a recipient address RCP.ADDR when an electronic message is sent to a recipient associated with the recipient address RCP.ADDR and a third interface signage I.SIGN3 that may be supplied rendered as the account signage 303 when an authorized user of the third tier 3 account requests that the rewards user interface 200 be rendered for viewing, access and reward selection.

The third exemplary reward account record REW.ACCT.REC.003 may further optionally include the first reward account identifier REW.ACCT1.ID of the tier 2 customer that authorized the instant third exemplary reward account record REW.ACCT.REC.003 to be created by the admin server 102, wherein the admin system 102 may optionally permit access to the third exemplary reward account record REW.ACCT.REC.003 by the identified tier 2 customer and may authorize the tier 2 customer to (a.) delete or modify the third exemplary reward account record REW.ACCT.REC.003; (b.) add or delete references to reward records REW.REC.003-REW.REC.N whereby authority by the tier 3 customer to purchase rewards identifiers by associated identifiers REW3.ID of the reward records REW.REC.003-REW.REC.N is created or removed; and/or (c.) adjust other aspects of the instant third reward account record REW.ACCT.REC.003. The third reward account record REW.ACCT.REC.003 may also include the first reward account password REW.PASS 1 associated with the first reward account record REW.ACCT.REC.001 associated with the tier 2 customer that authorized the admin system 102 to create and maintain the third reward account record REW.ACCT.REC.003.

The third exemplary reward account record REW.ACCT.REC.003 may further optionally include a platform account identifier PLAT.ID of the platform customer that authorized the instant third exemplary reward account record REW.ACCT.REC.003 to be created by the admin server 102, wherein the admin system 102 may optionally permit access to the third exemplary reward account record REW.ACCT.REC.003 by the identified platform customer and may authorize the platform customer to (a.) delete or modify the third exemplary reward account record REW.ACCT.REC.003; (b.) add or delete references to reward records REW.REC.003-REW.REC.N whereby authority by the tier 3 customer to purchase rewards identified by associated identifiers REW1.ID-REWN.ID of the reward records REW.REC.003-REW.REC.N is created or removed; and/or (c.) adjust other aspects of the instant third reward account record REW.ACCT.REC.003. A third platform account identifier PLAT3.ID may be or include a platform account record identifier, e.g., the second rewards account identifier REW.ACCT2.ID of a second, platform, rewards account REW.ACCT.REC.002 and/or the platform password REW.PASS2 of second rewards account REW.ACCT.REC.002.

An enablement indicator ON of a enabled/disabled flag data field FLAG indicates that the comprising reward account record REW.ACCT.REC.001-REW.ACCT.REC.N is fully authorized, i.e., bearing an enabled indicator ON. Disablement of a reward account record REW.ACCT.REC.001-REW.ACCT.REC.N may be affected by overwriting the enablement indicator ON with a disablement indicator OFF, as indicated in the tier 3 account record REW.ACCT.REC.003 FIG. 8C. The inclusion of the disablement indicator OFF in the exemplary tier 3 reward account record REW.ACCT.RED.003 is for the purpose of clarity of explanation of the enabled/disabled flag data field FLAG.

Referring now generally to the Figures and particularly to FIG. 8D, FIG. 8D is a block diagram depicting an exemplary first recipient record RCP.REC.001. It is understood that recipient database records RCP.REC.001-REC.REC.N may be stored at the admin server 102, the platform server 104, one or more tier 2 systems 106, and/or one or more tier 3 systems 108 & 110.

Each recipient record RCP.REC.001-RCP.REC.N preferably includes a recipient record identifier RCP.REC.ID, a recipient identifier RCP.ID, a recipient password RCP.PSW that may be used by a recipient or other party, to include a platform, tier 2 or tier 3 customer, to verify the relevant recipient's identity or authority to access an award, a recipient email address EMAIL, a recipient telephone number TEL, a recipient text message address TXT1, an actual name or persistent pseudonym NAME of a recipient, a network address NET.ADDR associated with a recipient and/or a postal address POSTAL.ADDR associated with a recipient.

The exemplary first recipient database record RCP.REC.001 preferably includes a first recipient record identifier RCP.REC1.ID, a first recipient identifier RCP1.ID that is associated with a first recipient, a first recipient password RCP.PSW1 that may be used by the first recipient to verify the first recipient's identity or authority to access an award, a first recipient email address EMAIL1 associated with the first recipient, a first recipient telephone number TEL1 associated with the first recipient, a first recipient text message address TXT1 associated with the first recipient, an actual name or persistent pseudonym NAME1 of the first recipient NAME1, a network address NET1.ADDR associated with the first recipient and/or a postal address POSTAL.ADDR1 associated with the first recipient.

Referring now generally to the Figures and particularly to FIG. 8E, FIG. 8E is a block diagram of an exemplary first interface request message IFR.MSG.001 as transmitted by a platform system 104, the tier 2 system 106 or a tier 3 system 108 & 110 to the admin server 104. The first interface request message IFR.MSG.001 specifies a rewards account identifier REW.ACCT1.ID-REW.ACCTN.ID and preferably a password PASSWORD1-PASSWORDN associated with the specified rewards account identifier REW.ACCT1.ID-REW.ACCTN.ID of the first interface request message IFR.MSG.001. The first interface request message IFR.MSG.001 preferably includes an admin server network address AD.ADDR as a destination network address and a sender network address S.ADDR of a system 104-110 initiating system 104-110.

Upon receipt of the first interface request message IFR.MSG.001 by the admin server 102, the admin server 102 first attempts to authenticate the supplied rewards account identifier REW.ACCT1.ID-REW.ACCTN.ID and password PASSWORD1-PASSWORDN of the first interface request message IFR.MSG.001. When the admin server 102 successfully authenticates the supplied rewards account identifier REW.ACCT1.ID-REW.ACCTN.ID and password PASSWORD1-PASSWORDN of the first interface request message IFR.MSG.001, the admin server issues an interface delivery message IFD.MSG-001-IFD.MSG.N.

FIG. 8F is a block diagram of an exemplary first interface delivery message IFD.MSG.001 as transmitted by the admin server 102 to the platform system 104, the tier 2 system 106, and/or a tier 3 system 108 & 110. Each interface delivery message IFD.MSG.001-IFD.MSG.N preferably includes a plurality of reward signages R.SIGN1-R.SIGNN that are associated with a same rewards account record REW.ACCT.REC.001-REW.ACCT.REC.N as identified by a received and authenticated interface delivery message IFD.MSG-001-IFD.MSG.N. Each reward signage R.SIGN1-R.SIGNN preferably includes data that may be rendered by a system 104-110 with the rewards user interface 200 to visually indicate a reward specified within a reward record REW.REC.001-REW.REC.N. Each interface delivery message IFD.MSG.001-IFD.MSG.N further preferably includes the admin server network address AD.ADDR as a sender address and a network address ACCT.ADDR of a system 104-110 that transmitted a corresponding and requesting interface request message IFR.MSG-001-IFR.MSG.N.

Referring now generally to the Figures and particularly to FIG. 8G, FIG. 8G is a block diagram depicting an example of an exemplary first reward selection message SMSG.001 as sent from the tier 2 system 106 or a tier 3 system 108 & 110 to an admin server 104. The first reward selection message SMSG.001 includes a selection message identifier SMSG.001, a destination address AD.ADDR of the admin server 102, a sender network address S.ADDR of the sending tier 2 system 106 or tier 3 system 108 & 110, a reward identifier REW1.ID-REWN.ID, as selected by a user of the rewards user interface 200 of the sending tier 2 system 106 or tier 3 system 108 & 110, a reward purchase value R.PRICE1-R.PRICEN as entered by a tier 2 or tier customer via the rewards user interface 200 of the sending tier 2 system 106 or tier 3 system 108 & 110, and a recipient data RCP.ADDR that informs the admin server 102 as what address to send reward transmission messages TMSG.001-TMSG.N to an identified recipient. The first reward selection message SMSG.001 may optionally include text or other data TXT that is to be provided to the recipient in a reward transmission message TMSG.001.

Referring now generally to the Figures and particularly to FIG. 8H, FIG. 8H is a block diagram of an exemplary first reward purchase message PMSG.001 as sent from the admin server 102 to a reward source server 112-116. The first reward purchase message PMSG.001 preferably includes a destination network address RS.ADDR of a reward source server 112-116, the admin network address AD.ADDR of the admin server 102 as the sender address, a reward identifier REW1.ID-REWN.ID and a purchasing authorization data DATA.PUR that includes financial account identification and financial account debiting authorization to be applied to purchase the reward associated with the reward identifier REW1.ID-REWN.ID included in the first reward purchase message PMSG.001.

Referring now generally to the Figures and particularly to FIG. 8I, FIG. 8I is a block diagram of an exemplary first reward fulfillment message FMSG.001 sent from a reward source server 112-116 to the admin server 102 in response to a successful purchase of a reward by processing of a reward purchase message PMSG.001-P.MSG.N. The first reward fulfillment message FMSG.01 preferably includes a destination network address of the admin network address AD.ADDR of the admin server 102 and the network address RS.ADDR of the sending reward source server 112-116, as the sender address. The exemplary first fulfillment message FMSG.01 further includes a reward account access data REW.ACCESS that enables a recipient to apply, access or help obtain a reward.

Referring now generally to the Figures and particularly to FIG. 8J, FIG. 8J is a block diagram of an exemplary first reward transmission message TMSG.001 as sent from the admin server 102 to a first reward recipient address RCP.ADDR1. The first reward recipient address RCP.ADDR1 may be an address sourced form a recipient record RCP.REC.001-RCP.REC.N, such as an email address, a telephone number, a texting service address, a postal address and/or other network address. The exemplary first reward transmission message TMSG.001 preferably includes a unique first reward transmission message identifier TMSG1.ID.

The exemplary first reward transmission message TMSG.001 further includes (a.) the reward account access data REW.ACCESS that may be applied to receive access to a rewards account RECORD REW.ACCT.REC as initiated by the admin server 102 and generated by a rewards source server 112-116; (b.) optionally a tier 2 or tier 3 signage M.SIGN1-M.SIGNN related to a tier 2 customer and/or a tier 3 customer that is displayed when the first reward transmission message TMSG.001 is rendered by the recipient system 118; and optionally ADDITIONAL data TXT that may be received by the admin server 102 as entered by a tier 2 customer or a tier 3 customer via the rewards user interface 200 of the tier 2 system 106 or tier 3 system 108 & 110.

The admin server 102 may retain a history of electronic messages, to include account formation and deletion messages, account funding messages, interface request messages IFR.MSG.001-IFR.MSG.N, interface delivery messages IFD.MSG.001-IFD.MSG.N, reward selection messages SMDG.001-SMSG.N, reward purchase messages PMSG.001-PMSG.N, reward fulfillment messages FMSG.001-FMSG.N and reward transmission messages TMSG.001-TMSG.N, and thereby maintain a history of activity of one or more reward account records REW.ACCT.REC.001-REW.ACCT.REC.N, associated reward accounts, reward values and reward value redemption

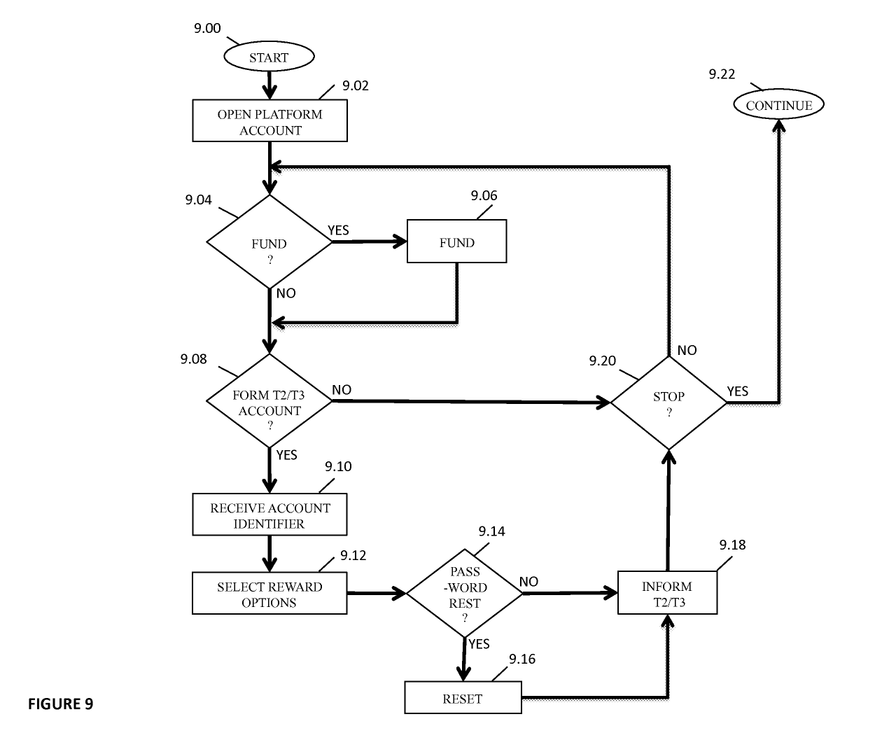

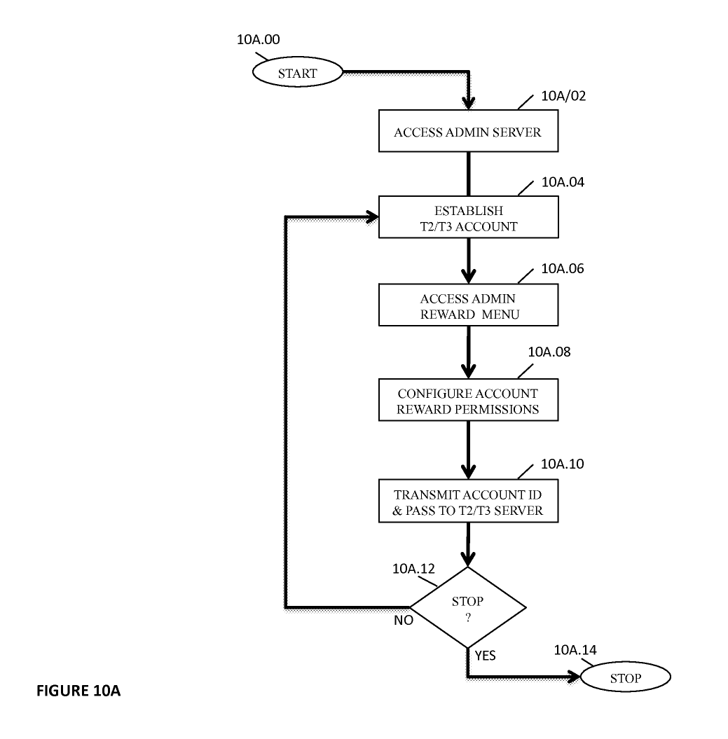

Referring now generally to the Figures and particularly to FIG. 9, FIG. 9 is a software flowchart establishing a tier 2 customer account record REW.ACCT.REC.001 or a tier 3 customer account REW.ACCT.REC.003 at the admin server 102. The platform server 104 messages the admin server 102 in step 9.02 and requests the admin server 102 to form a platform account record REW.ACCT.REC.002 which the platform server 104 may then optionally fund the newly created platform account record REW.ACCT.REC.002 in steps 9.04 and 9.06 by electronic funds transfer. The platform server 104 next directs the admin server 102 in steps 9.08 through 9.12 to create a tier 2 account record REW.ACCT.REC.001 or a tier 3 account record REW.ACCT.REC.003. The platform server 104 receives an identifier of the newly formed tier 2 account record REW.ACCT.REC.001 and first account password REW.PASS1 or the tier 3 account record REW.ACCT.REC.003 and third account password REW.PASS3 in step 9.10 and authorizes the admin server 102 in step 9.12 to enable certain reward option selections by the tier 2 system 106 and/or tier 3 system 108 & 110. The platform server 104 may optionally reset the account password REW.PASS1 OR REW.PASS3. The platform server 104 informs a tier 2 customer or a tier 3 customer of the relevant and current password REW.PASS1 or REW.PASS3 in step 9.18 preferably by messaging to a system 106-110. The platform server 104 proceeds from step 9.18 to step 9.20 and to determine whether to proceed to step 9.04 or alternately to step 9.22 and to perform alternate computational operations.

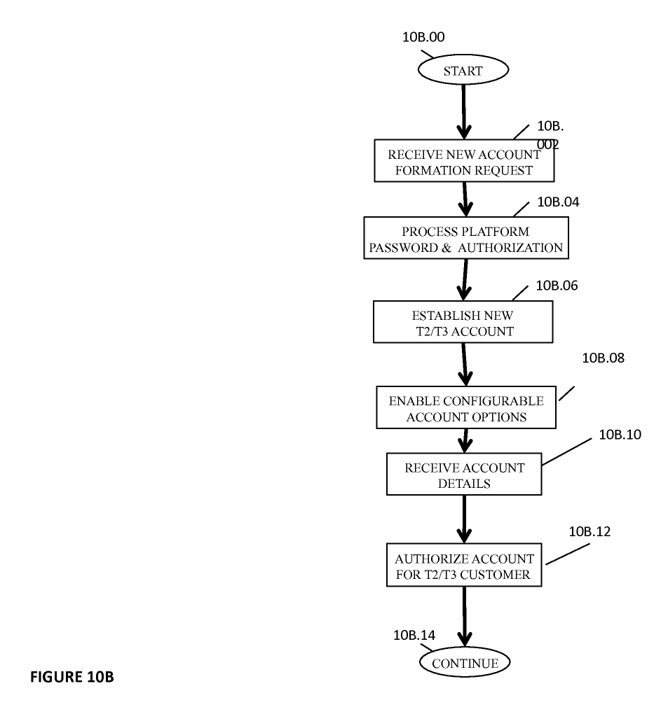

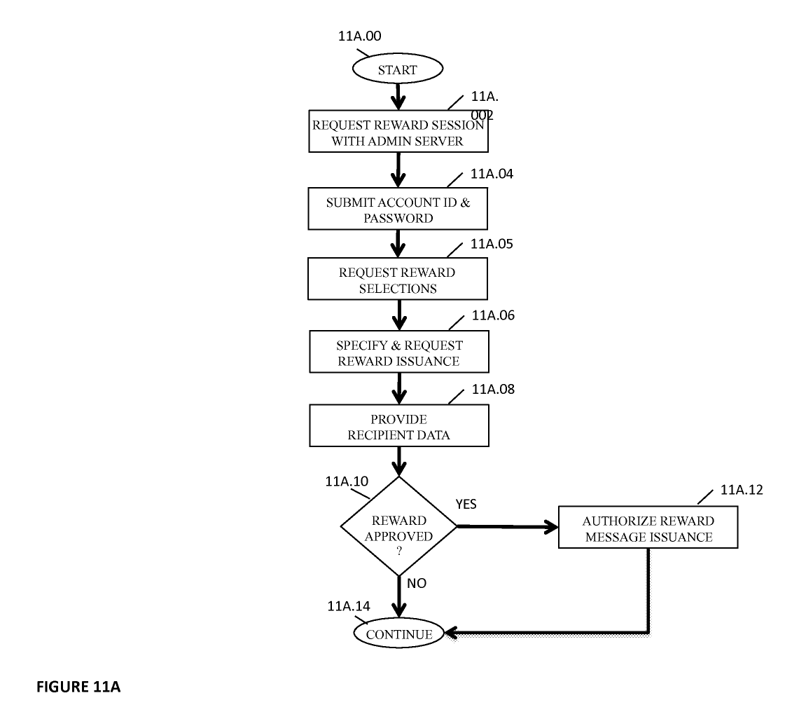

Referring now generally to the Figures and particularly to FIG. 10A, FIG. 10A is a flow chart depicting the platform server 104 creating tier 2 and tier 3 customer account records REW.ACCT.REC.001 & REW.ACCT.REC.003 at the admin server 102. The platform server 104 initiates communication with the admin server 102 in step 10A.02 and requests that the admin server 102 establish a tier 2 or tier 3 account record REW.ACCT.REC.001 & REW.ACCT.REC.003 in step 10A.04. The platform server 104 next accesses the full rewards options menu 800 of the admin server 102 in step 10A.06 and selects permitted rewards identifiers REW1.ID-REWN.ID for inclusion in the newly established tier 2 or tier 3 account record REW.ACCT.REC.001 & REW.ACCT.REC.003 in step 10A.08 and informs the admin server 102 of the reward permissions to be associated with, and reward identifiers REW1.ID-REWN.ID to be included in, the newly established tier 2 or tier 3 account record REW.ACCT.REC.001 & REW.ACCT.REC.003. The platform server 104 then provides an account identifier REW.ACCT1.ID & REW.ACCT3.ID and optionally an account password REW.PASS1 & REW.PASS3 to the relevant tier 2 system 106 and or tier 3 system 108 & 110 in step 10A.10. The platform server 104 then determines in step 10A.12 whether to request a generation of another tier 2 or tier 3 account record REW.ACCT.REC.004-REW.ACCT.REC.N by the admin server in step 10A.12 or to proceed on to step 10A.14 and perform additional or alternate computational processing.

Referring now generally to the Figures and particularly to FIG. 10B, FIG. 10B is a flow chart of the admin server 102 creating tier 2 and tier 3 customer account records REW.ACCT.REC.001-REW.ACCT.REC.003 as requested by the platform server 104. The admin server 102 receives the new tier 2 or tier 3 account record formation request in step 10B.02 and processes the platform password REW.PASS2 and confirms platform server authorization in step 10B.04. The admin server 102 next establishes the new tier 2 or tier 3 account record REW.ACCT.REC.001 or REW.ACCT.REC.003 in step 10B.06 and enables configurable account options for the new tier 2 or tier 3 account record REW.ACCT.REC.001 or REW.ACCT.REC.003 in step 10B.08, to include reward options. The admin server 104 receives and populates account data and selections received from the platform server 104 into the new tier 2 or tier 3 account record REW.ACCT.REC.001 or REW.ACCT.REC.003 in step 10B.10. The admin server 104 than authorizes the new tier 2 or tier 3 account the new tier 2 or tier 3 account record REW.ACCT.REC.001 or REW.ACCT.REC.003 in step 10B.12 and proceeds on to step 10B.14 to perform additional or alternative computational processes.

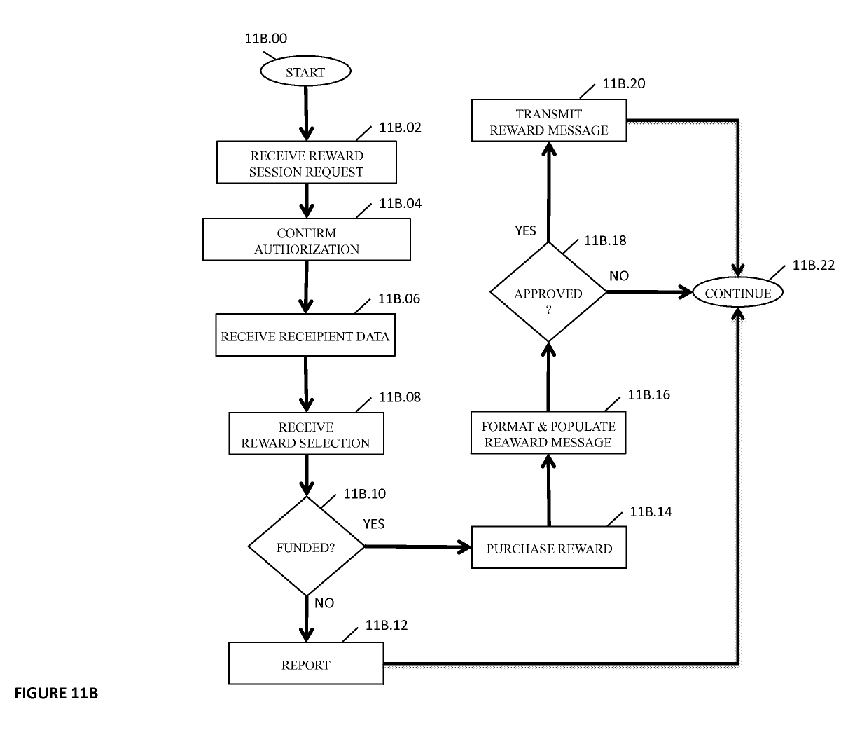

Referring now generally to the Figures and particularly to FIG. 11A, FIG. 11A is a flow chart of a tier 2 system 106 interacting the admin server 102 and specifying and requesting an issuance of a reward to a recipient. The tier 2 system 106 requests a reward session with the admin server 102 in step 11A.02 and specifies a tier 2 account identifier REW.ACCT1.ID in step 11A.04. The tier 2 system 106 then proceeds to provide the admin server 102 with the recipient's data RCP.DATA in step 11A.06 and both specifies and requests a reward issuance in step 11A.08. In step 11A.10 the tier 2 system 106 determines if the admin server 102 has authorized a purchase and issuance of the reward requested in step 11A.08. When the tier 2 system 106 determines the admin server 102 has authorized a purchase and issuance of the requested reward, the tier 2 system authorizes a reward message issuance addressed to the recipient in step 11A.12, wherein the reward message includes reward account information REW.ACCESS sufficient to allow the recipient to access and receive the requested and associated reward. In the alternative if the tier 2 system 106 determines the admin server 102 has not authorized a purchase and issuance of the requested reward, the tier 2 system 106 proceeds on to step 11A.14 to perform additional or alternative computational processes.

Referring now generally to the Figures and particularly to FIG. 11B, FIG. 11B is a flow chart of an admin server 102 receiving a specified issuance of a reward from a tier 2 system 106 wherein the reward is to be sent to a recipient. The admin server 102 receives a request for a reward session from the tier 2 system 106 in step 11B.02 and confirms authorization of access to the tier 2 account record REW.ACCT.REC.001 in step 11B.04. The admin server 102 then receives the recipient address RCP.ADDR in step 11B.06 from the tier 2 system 106 and a selected reward identifier REW1.ID-REWN.ID in step 11B.08. In step 11B.10 the admin server 102 determines if the tier 2 account record REW.ACCT.REC.001 indicates sufficient funding of the purchase of the selected reward requested in step 11B.08. When the admin server 102 determines the tier 2 account record REW.ACCT.REC.001 indicates sufficient funding of a purchase of the requested reward, the admin server 102 authorizes the requested reward selection in step 11B.08 and purchases the reward from a rewards source server 112-116 in step 11B.14. In the alternative if the admin server 102 determines the tier 2 account record REW.ACCT.REC.001 does not indicate sufficient funding of a purchase of the requested reward, the admin server 102 proceeds on to step 11B.22 to perform additional or alternative computational processes. After the admin server 102 purchases a reward in step 11B.14 from a rewards source server 112-116, the admin server 102 formats and populates the reward transmission message TMSG.001 that includes reward account information REW.ACCCESS sufficient to allow the recipient to access and receive the requested reward. The admin server 102 then proceeds to approve the formatted and populated reward message TMSG.001 in step 11B.18. If the reward transmission message TMSG.001 is approved by tier 2 system 106 in step 11B.18, the admin server 102 transmits the reward message reward transmission message TMSG.001 in step 11B.20 to the recipient server 118. The admin server 102 proceeds on to step 11B.22 to perform additional or alternative computational processes. In the alternative if the admin server 102 determines the tier 2 system 106 has not authorized the formatted and populated transmission reward message TMSG.001, the admin server directly from step 11B.18 to step 11B.22.

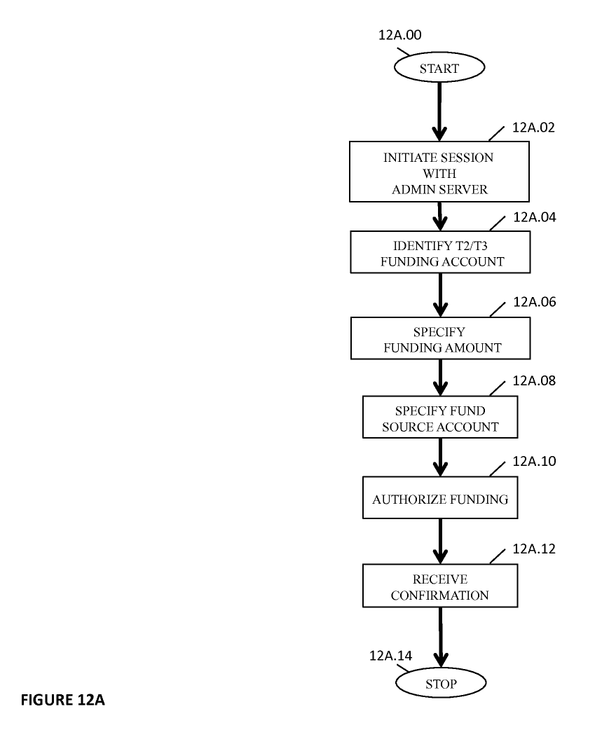

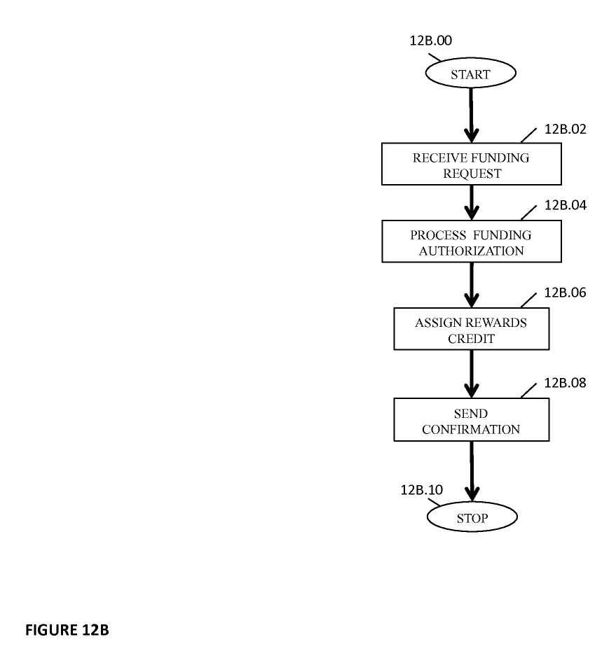

Referring now generally to the Figures and particularly to FIG. 12A, FIG. 12A is a flow chart of a tier 2 system 106 initiating a funding session with an admin server 102. The tier 2 system 106 in step 12A.02 initiates a funding session with an admin server 102 and in step 12A.04 the tier 2 system identifies tier 2 or tier 3 account record REW.ACCT.001 OR REW.ACCT.REC.003 intended for funding. The tier 2 system 106 next specifies the funding amount in step 12A.06 and the funding source account in step 12A.08 from which the funds are provided. When the funding amount is specified in step 12A.06 and the funding source account has been specified in step 12A.08, the tier 2 system 106 proceeds in step 12A.10 to authorize the funding amount specified in step 12A.06 from the funding source account identified in step 12A.08 to admin server 102. In step 12A.12 tier 2 system 106 receives confirmation from admin server 102 that the authorize funding in step 12A.10 has been accomplished and recorded in the relevant tier 2 or tier 3 rewards account record REW.ACCT.001 or REW.ACCT.REC.003. The tier 2 system 106 proceeds on from step 12A.12 to step 12A.14 to perform additional or alternative computational processes.

Referring now generally to the Figures and particularly to FIG. 12B, FIG. 12B is a flow chart of an admin server 102 receiving funding from a tier 2 system 106 and from a tier 2 account or a tier 3 account REW.ACCT.REC.001-REW.ACCT.REC.003. The admin server 102 receives a request for a funding session from the tier 2 system 106 in step 12B.02 and processes the authorized funds from the identified tier 2 funding source specified by tier 2 system 106. When funding is successfully received and authenticated in step 12B.04, the admin server 102 proceeds to step 12B.06 to assign the rewards credit to the tier 2 account record REW.ACCT.REC.001 or tier 3 account record REW.ACCT.REC.003 specified in step 12B.04. In step 12B.08 admin server 102 sends confirmation to tier 2 system 106 confirming allocation of the assigned rewards credit of step 12B.06. The admin server 102 then proceeds on to step 12B.10 to perform additional or alternative computational processes.

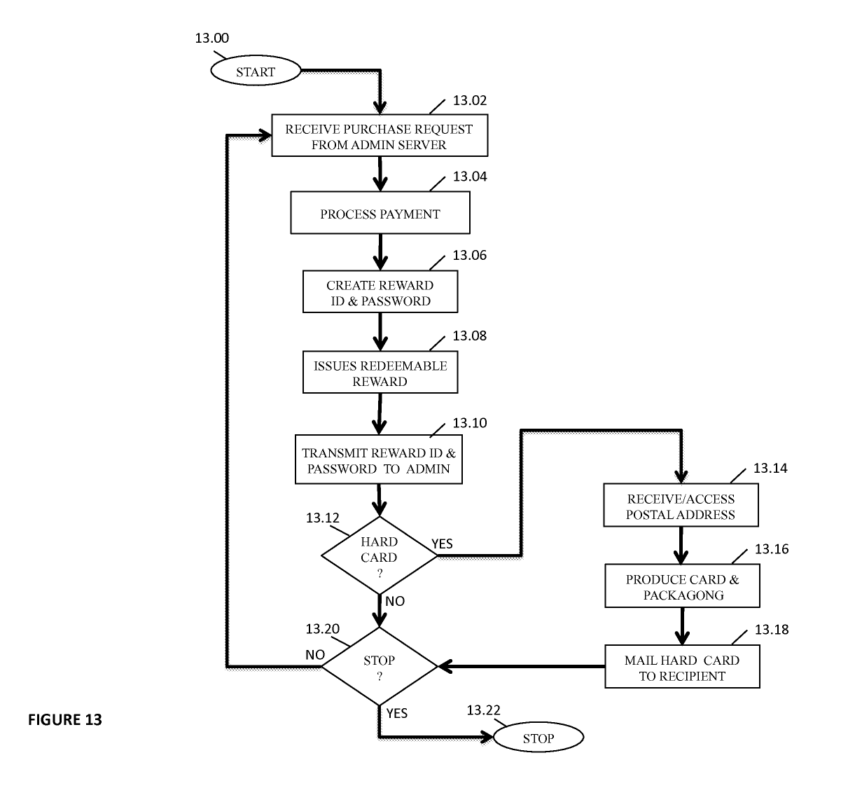

Referring now generally to the Figures and particularly to FIG. 13, FIG. 13 is a flow chart of a reward source server 112 receiving and fulfilling a reward purchase request from the admin server 102. The reward source server 112 receives a purchase message PMSG.001 in step 13.02 from the admin server 102 and processes the offered payment information in step 13.04. The reward source server 112 then generates the reward access information REW.ACESS in step 13.06.

After the reward source server 112 issues the redeemable reward in step 13.08, the reward source server 112 proceeds to transmit the reward access information REW.ACESS to the admin server 102 in step 13.10. When the generated reward access information REW.ACESS has been successfully transmitted to the admin server 102, the reward source server 112 proceeds from step 13.10 to step 13.12 to determine if a hard card was requested by the admin server 102.

If in step 13.12 the reward source server 112 determines that a hard card creation and shipment was requested by the admin server 102, the reward source server 112 proceeds to step 13.14 to receive or access the recipient's postal address POSTAL.ADDR from the admin server 102. When the reward source server 112 has received or successfully accessed or received the postal address POSTAL.ADDR, the reward server 112 proceeds in step 13.16 to produce the hard card and required postal packaging. Proceeding from step 13.16 to step 13.18 the reward source server 112 mails the hard card by postal services to the recipient. In the alternative if the admin server 102 did not request a hard card from the reward source server 112 then the reward source server 112 proceeds to step 13.20 to determine if the reward source server 112 should proceed on to another execution of loop 13.02 through 13.20. Alternatively, reward source server 112 may proceed from step 13.20 to step 13.22 and perform additional or alternative computational processes.

The foregoing disclosures and statements are illustrative only of the Present Invention, and are not intended to limit or define the scope of the Present Invention. The above description is intended to be illustrative and not restrictive. Although the examples given herein include many specificities, they are intended as illustrative of only certain possible configurations or aspects of the Present Invention. The examples given should only be interpreted as illustrations of some of the preferred configurations or aspects of the Present Invention and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the present invention as disclosed and claimed should, therefore, be determined with reference to the knowledge of one skilled in the art and in light of the disclosures presented above.

What is claimed is:

1. A system comprising:
a. A rewards service server (“rewards server”) adapted to provide a plurality of distinguishable rewards account managers with reward selection options and enable communication of reward account information in a rewards network; and
b. the reward network comprising a plurality of client software operating on separately addressable client machines, wherein each client software is adapted to render and offer an associated plurality of distinguishable reward selection options as made accessible by the rewards server for selection by an account manager.

2. The system of claim 1, wherein the reward server is further adapted to assign a customized plurality of reward selections to at least one client software.

3. The system of claim 1, wherein at least one client software is adapted to enable a reward account generation, the reward account specifying a reward value redeemable via the rewards application.

4. The system of claim 3, wherein the at least one client software is adapted to request a reward value redemption.

5. The system of claim 4, wherein the at least one client software is adapted to disable a reward account.

6. The system of claim 4, wherein the at least one client software is adapted to issue an electronic reward notification message to a beneficiary of the reward account.

7. The system of claim 4, wherein the at least one client software is adapted to accept an instruction to issue a gift card.

8. The system of claim 4, wherein the at least one client software is adapted to report a current reward value balance of the reward account.

9. The system of claim 4, wherein the system is adapted to report at least one current reward value balances of a plurality of reward accounts.

10. The system of claim 9, wherein the plurality of reward accounts are issued by the at least one client software.

11. The system of claim 2, wherein the at least one client software is adapted to enable adjustment of the reward value, wherein the at least one client software is enabled to increase or decrease the reward value.

12. The system of claim 1, wherein the at least one client software is adapted to direct issuance of a custom reward and authorize communication of the custom award to a recipient address via the rewards application.

13. The system of claim 1, wherein the rewards server is adapted to maintain an editable catalog of rewards.

14. The system of claim 1, wherein the rewards server is adapted to maintain a history of activity of reward values and reward value redemption.

15. The system of claim 1, wherein the rewards servers is adapted to issue an electronic reward notification message to a beneficiary of the reward account.

16. A computer-implemented method comprising:
a. providing a rewards server via an electronic communications network, the rewards server, the rewards server adapted to provide a plurality of distinguishable user selection groupings to enable selection and communication of reward account information in a rewards network;
b. enabling access to the reward network via the electronic communications network, the reward network comprising a plurality of client software operating on separately addressable client machines, wherein the rewards server is adapted to maintain and present a first plurality of distinguishable reward selection options via a first client software and a second plurality of distinguishable reward options via a second client software.

17. A computer implemented method for managing a reward accounts system for a customer comprising:
a. a graphical user interface adapted for interaction with the customer over a computer network to authorize the customer to generate a plurality of reward accounts;
b. receiving funding from the customer;
c. generating a plurality of reward accounts as directed by the customer via the graphical user interface; and
d. disbursing the funding among the plurality of reward accounts as directed by the customer via the graphical user interface.

18. A computer implemented method for managing a reward accounts system for a customer comprising:
a. interacting with a data processing system using a graphical user interface with the customer over a computer network to enable the customer to direct the data processing system to execute the following instructions:
i. create a reward account;
ii. assign a password to the reward account;
iii. reset the password of the reward account;
iv. electronically transfer funds to the reward account;
v. access a financial balance of the reward account;
vi. assign at least one reward option to the reward account; and
vii. delete the reward account; and
b. presenting the customer with a plurality of reward options from which the at least one reward option is selected via the graphical user interface.

19. A data processing system comprising:
a. means to bi-directionally communicatively couple the data processing system with a computer network;
b. means to interact with a customer using a graphical user interface to enable the customer via the computer network to direct the data processing system to generate a plurality of reward accounts;
c. means to receive a transfer of funds as directed by the customer;
d. means to generate a plurality of reward accounts; and
e. means to disburse the funds among the plurality of reward accounts as directed by the customer via the graphical user interface.
